(19) United States
(12) Patent Application Publication
(10) Pub. No.: US 2015/0170809 A1
(43) Pub. Date: Jun. 18, 2015

(54) SINTERED MAGNET AND PROCESS FOR PRODUCTION THEREOF

(71) Applicants: Matahiro Komuro, Tokyo (JP); Yuichi Satsu, Tokyo (JP); Takao Imagawa, Tokyo (JP)

(72) Inventors: Matahiro Komuro, Tokyo (JP); Yuichi Satsu, Tokyo (JP); Takao Imagawa, Tokyo (JP)

(73) Assignee: HITACHI, LTD., Tokyo (JP)

(21) Appl. No.: 14/404,406

(22) PCT Filed: May 30, 2012
(86) PCT No.: PCT/JP2012/003518

§ 371 Date: Nov. 26, 2014

(51) Int. Cl. H01F 1/057; B22F 3/10; C22C 38/00; C22C 38/10; C22C 38/02; C22C 38/14; C22C 38/28; C22C 38/30; C22C 38/12; C22C 12/00; H01F 41/02; C22C 38/16

(52) U.S. Cl. CPC H01F 1/0577; H01F 41/0253; B22F 3/10; H01F 41/0293; C22C 38/005; C22C 38/002; C22C 38/105; C22C 38/16; C22C 38/14; C22C 38/28; C22C 38/30; C22C 38/12; C22C 12/00; C22C 38/02

(57) ABSTRACT

The purpose of the present invention is to improve the magnetic characteristics of a sintered magnet without any additional heavy rare earth element. A sintered magnet composed of an NdFeB main phase and a grain boundary phase, wherein; the grain boundary phase contains an oxyfluoride; the concentration of fluorine in the oxyfluoride is higher than that of oxygen therein; the concentration of fluorine in the oxyfluoride decreases depthwise from the surface of the sintered magnet toward the center thereof; and the saturation magnetic flux density of the sintered magnet decreases depthwise from the surface of the sintered magnet toward the center thereof.

### TECHNICAL FIELD

The present invention relates to a sintered magnet containing fluorine and a process for producing the same.

### BACKGROUND ART

A sintered magnet has been applied to various magnetic circuits. Especially, an NdFeB-based sintered magnet is a high-performance magnet including an Nd₂Fe₁₄B-based crystal as a main phase, and it is used in a wide range of products for motor vehicles, industry, power generation equipment, household appliances, medical services, electronic equipment, and the like, and the amount of the NdFeB-based sintered magnet used has increased. Expensive heavy rare earth elements such as Dy and Tb are used in the NdFeB-based sintered magnet for insuring heat resistance in addition to Nd which is a rare earth element. These heavy rare earth elements are skyrocketing in prices since they are rare; their resources are unevenly distributed; and resource conservation is required. Therefore, the requirement to reduce the amount of heavy rare earth elements used has been increasing.

As a technique capable of reducing the amount of heavy rare earth elements used, there has been known a grain boundary diffusion method in which a material containing a heavy rare earth element is applied to the surface of a sintered magnet and then diffused, and Patent Literature 1 discloses a sintered magnet to which this technique is applied. Further, Patent Literature 2 discloses a sintered magnet in which a technique of using a vapor containing a heavy rare earth element to diffuse the heavy rare earth element from the surface of the sintered magnet has been employed.

Patent Literature 3 discloses that, also in a sintered magnet in which a fluoride is applied and diffused into the surface of the sintered magnet, the amount of a heavy rare earth element used can be reduced, and an oxyfluoride is formed in a grain boundary of the sintered magnet.

Patent Literature 4 discloses that in a fluorination technique using xenon fluoride fluorine can be applied to fluorine-interstitial compounds such as a SmFeF-based compound which serves as a main phase of a magnet material.

Patent Literature 5 describes the concentration of a halogen element in a magnet produced by adding a fluoride followed by sintering. Further, Patent Literature 6 describes a fluorination technique using fluorine (F₂) gas.

### CITATION LIST

### Patent Literature

### Patent Literature 1: WO 2009/513990

### Patent Literature 2: JP-A-2009-124150

### Patent Literature 3: JP-A-2008-147634

### Patent Literature 4: JP-A-2011-211106

### Patent Literature 5: JP-A-03-188241

### Patent Literature 6: JP-A-06-244011

### SUMMARY OF INVENTION

### Technical Problem

In the above Patent Literatures 1 to 3, a material containing a heavy rare earth element is used, and the heavy rare earth element is diffused and unevenly distributed along a grain boundary from the surface of a NdFeB-based sintered magnet. These are techniques of adding from the outside the heavy rare earth element to a NdFeB-based sintered magnet which is a base material. In these prior art, the heavy rare earth element is newly added by diffusion for improving magnetic characteristics of a sintered magnet, and it is difficult to realize improvement in the magnetic characteristics of the sintered magnet without additional use of the heavy rare earth element.

An object of the present invention is to improve the magnetic characteristics of a sintered magnet without adding a heavy rare earth element.

### Solution to Problem

One of the means to prepare a sintered magnet of the present invention is to employ a step of fluorinating a grain boundary with a dissociative fluorinating agent to form an oxyfluoride and a fluoride in a NdFeB grain boundary or crystal grain at low temperature, thus changing the structure of the sintered magnet.

The dissociative fluorinating agent can generate a fluorine radical at a lower temperature than a diffusion heat treatment temperature and can fluorinate a magnet material at a low temperature of 50 to 400° C. A representative example thereof is xenon fluoride (Xe—F— based compound), with which fluorine can be easily introduced into a sintered magnet in the above temperature range. Dissociated fluorine is introduced into a sintered magnet, but xenon is hardly introduced into the sintered magnet because xenon is poor in reactivity and cannot easily form a compound with an element constituting the sintered magnet.

Since the dissociated or decomposed active fluorine is introduced mainly along the grain boundary where the concentration of a rare earth element and the concentration of oxygen are high and bonded to various elements constituting the sintered magnet, it is diffused into the grain boundary or the grain and forms various fluorine compounds (fluoride). In the case of a rare earth sintered magnet, an acid-fluorine compound (oxyfluoride) or a fluoride each containing a rare earth element easily grows, and fluorine is diffused along the grain boundary. The amount of fluorine to be introduced can be controlled by fluorination conditions, and an oxyfluoride that contains fluorine at a higher concentration than the concentration of oxygen in the oxyfluoride can also be formed. Such oxyfluoride having a high concentration of fluorine absorbs a part of elements including magnet-constituting elements and trace additive elements, which are easily bonded to fluorine, and changes the composition and structure in the vicinity of the grain boundary.

Introducing only fluorine into the sintered magnet as described above significantly improves magnetic characteristics according to the following mechanisms. 1) Fluorine atoms at the grain boundary surface attract electrons and impart anisotropy to the electron density of states of adjacent crystals. 2) Since fluorine atoms have negative charge, the charge of a rare earth element is increased to the positive side in the vicinity of a high-concentration fluorine compound. Interface magnetic anisotropy is imparted by the change of charge. 3) The atomic arrangement of the interface of crystals which are adjacent to a fluoride and a crystal which contacts the interface is changed by the influence of the bias of the above electron density of states or charge balance, and occurrence of a lattice strain, reduction in symmetry of a lattice, and introduction of a hole are observed, thus increasing anisotropy energy.

The change of composition and structure by introducing fluorine as described above influences the magnetic properties in the vicinity of the fluoride and increases coercive force. Since such fluorine introduction diffuses excessive fluorine exceeding the concentration of fluorine that is stable in terms of energy into the sintered magnet, a metastable compound containing excessive fluorine is formed. Since the structure of the metastable fluoride is easily changed by heat treatment, coercive force is increased also by controlling the diffusion after fluorination and the conditions of aging heat treatment.

Specific techniques of the present invention will be described in Examples, but the features of representative sintered magnets having improved magnetic characteristics will be shown below. 1) Only dissociated fluorine is diffused from the surface of the sintered magnet, and the concentration of fluorine decreases from the surface of the sintered magnet toward the inner part. The concentration gradient of elements other than fluorine in an analysis area of 100 μm² from the surface of the sintered magnet toward the inner part thereof does not change before and after fluorination treatment, but the composition distribution in the vicinity of the grain boundary changes after fluorination treatment. This is because elements which are easily bonded to fluorine, such as Ga, Zr, Al, and Ti, are diffused and moved from the inside of the grain to the vicinity of the grain boundary by excessive fluorine introduced into the grain boundary. 2) The growth of a fluoride or an oxyfluoride by the introduction of only fluorine is significant on the surface of the sintered magnet, and the amount of the growth of the fluoride in the inner part is smaller than that on the surface of the sintered magnet. The degree of decomposition of the main phase, the amount of the metastable fluoride or oxyfluoride excessively containing fluorine, the lattice strain and charge transfer adjacent to the fluorine-containing compound, the decomposition of the main phase crystal, fluorine substitution to the main phase crystal, and fluorine entering into the main phase crystal are all remarkable on the surface of the sintered magnet and small in the central part of the sintered magnet. 3) When the grain boundary contains a rare earth element and oxygen, an oxyfluoride having a higher concentration of fluorine than the concentration of oxygen grows, and at least one element among the elements constituting the magnet, additive elements, and impurity elements is observed in the oxyfluoride and fluoride. 4) The supplied fluorine is diffused and unevenly distributed in the grain boundary phase rather than in the main phase and forms an oxyfluoride which contains a higher concentration of fluorine than the concentration of oxygen. There are a plurality of phases constituting the sintered magnet, if the grain boundary phase is included, and the grain boundary phase which is most easily bonded to fluorine is mainly fluorinated. Only fluorine can be introduced into the sintered magnet utilizing the selectivity of fluorination as described above. Further, the oxyfluoride is a metastable phase and is converted to a stable phase when it is heated to a temperature of 900° C. or more.

The above features can be realized for the first time by employing a technique capable of excessively supplying active fluorine to a sintered magnet material, and these features cannot be realized by a fluorine-introducing technique using the conventional stable fluoride or oxyfluoride.

### Advantageous Effects of Invention

The magnetic characteristics of a sintered magnet can be improved by the present invention without adding a heavy rare earth element.

### BRIEF DESCRIPTION OF DRAWINGS

FIG. 1 shows a concentration distribution after fluorination treatment.

FIG. 2 shows a concentration distribution after fluorination treatment.

FIG. 3 shows a concentration distribution after fluorination treatment.

FIG. 4 shows the structure of the cross section of a sintered magnet after fluorination treatment.

### DESCRIPTION OF EMBODIMENTS

Hereinafter, Examples of the present invention will be described in detail.

### Example 1

In a (Nd, Dy)₂Fe₁₄B sintered magnet, Cu, Ga, Al, and Co are mixed with a raw material powder before sintering each in a concentration range of 0.1 to 2 atom %, and the resulting powder is mixed with a powder having a higher concentration of a rare earth element than (Nd, Dy)₂Fe₁₄B, temporarily molded in a magnetic field, and then subjected to liquid phase sintering at 1000° C. The resulting sintered body is immersed in a slurry or a colloidal solution in which XeF₂ and a Co complex (β-diketone) are dispersed, which is heated to a temperature range of 50 to 150° C. Thereby, XeF₂ is decomposed to produce fluorine, which is introduced into the sintered body, and the Co complex is decomposed to produce Co, which is introduced into the sintered body from the surface thereof. In this temperature range, the fluorine is deposited in the grain boundary of (Nd, Dy)₂Fe₁₄B particles, and the fluorine and Co are diffused in the grain boundary where the concentration of rare earth elements is high by the aging heat treatment after fluorine introduction.

The average particle size of XeF₂ is in the range of 0.1 to 1000 μm. XeF₂ having an average particle size of less than 0.1 μm easily sublimates, and it is difficult to supply a sufficient amount of fluorine to a sintered magnet. Further, if the average particle size exceeds 1000 μm, fluorination reaction will be heterogenous, resulting in a local generation of heat and a growth of an oxide or an oxyfluoride containing residual oxygen, and it is difficult to diffuse fluorine in a grain boundary.

When fluorine is diffused into the grain boundary, composition, structure, interface structure, and the like of the grain boundary and in the vicinity of the grain boundary will change largely, and the magnetic characteristics of the sintered magnet will be improved. A part of a grain boundary phase before fluorine introduction changes with fluorination treatment from (Nd, Dy)₂O₃₋ₓ(0<x<3) to (Nd, Dy)ₓO_{y}F_{z} (where x, y, and z each represents a positive number). Further, the concentration of fluorine in an oxyfluoride after the fluorine introduction changes in the thickness direction of the sintered magnet; the concentration of fluorine is high on the surface of the magnet; and the concentration of fluorine is higher than the oxygen concentration of the oxyfluoride.

A demagnetizing curve immediately after the fluorine introduction is measured as a stepped demagnetizing curve having a distribution in coercive force. Fluorine and the main phase constituent element are diffused by an aging heat treatment at 400 to 800° C., and a component having a small coercive force disappears from the demagnetizing curve. The saturation magnetic flux density after fluorine introduction increases by 0.01 to 20% from that before the fluorine introduction. The increase in saturation magnetic flux density leads to the increase in residual magnetic flux density, and a maximum energy product increases from that before the fluorine introduction. Unreacted fluorine and the like which are released from the sintered magnet can also be removed by the aging heat treatment at 400 to 800° C. Fluorine is diffused into a grain-boundary triple point to allow easy formation of a stable oxyfluoride, thereby making the coercive force after the fluorination treatment equivalent to the coercive force before the fluorination treatment. Therefore, the aging heat treatment temperature after the fluorination treatment is preferably lower than 800° C.

Fluorine is unevenly distributed in the grain boundary after the fluorine introduction as described above, and 5 to 90% of the grain boundary is in the form of a fluoride or an oxyfluoride. The crystal structure thereof is mainly cubic, and monoclinic, orthorhombic, hexagonal, rhombohedral, tetragonal, and amorphous structures are also observed. A part of fluorine atoms is diffused into the main phase crystal grain and the grain-boundary triple point other than a grain boundary, and Fe or a Fe alloy of a bee or bet structure grows from a part of the main phase. Here, the Fe alloy refers to a FeₓM_{y} alloy or a FeₕMᵢFⱼ alloy. M represents an element added to a raw material powder before sintering or at least one element diffused with fluorine introduction from the surface of the magnet after sintering, and x, y, h, i, and j each represents a positive number. Since the amount of fluorine diffused into the main phase crystal grain is high in the vicinity of the surface of the sintered magnet, the amount of Fe in the bcc or bet structure, a FeₓM_{y} alloy, or a FeₕMᵢFⱼ alloy is higher in the vicinity of the surface of the sintered magnet (outer side of the sintered magnet) than in the central part thereof. A part of fluorine-containing Fe-based alloys has a lattice constant shorter than that of Fe (0.2866 nm) by 0.01 to 10%, and a part of the fluorine-containing phase is observed also in the inner part of the main phase crystal grain.

The Fe, FeₓM_{y} alloy, or FeₕMᵢFⱼ alloy of the bcc or bct structure by itself has a coercive force of 0.1 to 10 kOe and a saturation magnetic flux density in the range of 1.6 to 2.4 T. The coercive force is smaller than that of (Nd, Dy)₂Fe₁₄B only, and the saturation magnetic flux density are larger than that of (Nd, Dy)₂Fe₁₄B only. Therefore, magnetic reversion is suppressed by magnetic coupling with (Nd, Dy)₂Fe₁₄B, and a demagnetizing curve, which, in a magnetic field that is 80% or less of the coercive force, had an inflexion point in the second quadrant of the demagnetizing curve immediately after the fluorine introduction, is changed to a flat demagnetizing curve.

In order to suppress the change of residual magnetic flux density by an external magnetic field, it is effective to increase the volume fraction of the FeₓM_{y} alloy or the FeₕMᵢFⱼ alloy of an hcp structure or an L10 structure in which fluorine has entered in a range of 0.1 to 50%. Particularly, an ordered alloy in which fluorine has entered can be formed by the fluorination treatment in a magnetic field, heat treatment in a magnetic field after the fluorination, or plastic deformation after the fluorination.

In the magnet prepared under the preparation conditions of the present Example, the sintered magnet, in which its residual magnetic flux density is variable by an external magnetic field, and its maximum energy product is 40 MGOe or more and 70 MGOe or less, has an Nd₂Fe₁₄B-based phase and a FeCo-based phase as a main phase. A fluorine-containing phase is observed in the main phase grain boundary and the inner part of the main phase, and the proportion of the fluorine-containing phase in the FeCo-based phase which is one of the main phases and the inner part of the main phase shows a tendency that the proportion increases as it approaches the surface from the center of the sintered magnet.

The fluorine introduction technique as described in the present Example can be applied to a Mn-based magnetic material, a Cr-based magnetic material, a Ni-based magnetic material, and a Cu-based magnetic material in addition to the (Nd,Dy)₂Fe₁₄B sintered magnet. By introducing fluorine into an alloy phase which does not show ferromagnetism before the fluorine introduction, the position of fluorine is ordered, or an atomic pair of fluorine and another light element is ordered, thus largely changing the electronic state of a metal element to which a fluorine atom having high electronegativity is adjacent to thereby produce anisotropy in the distribution of electron density of states to produce ferromagnetism or hard magnetism.

In addition to utilizing the decomposition reaction of the XeF-based compound of the present Example, fluorine-containing radicals, fluorine-containing plasma, and fluorine-containing ions which are generated utilizing a chemical change between an inert gas element other than Xe and a compound of fluorine can be utilized as a fluorinated material for introducing fluorine, and a sintered magnet can be fluorinated by contacting or irradiating the surface of the sintered magnet with these fluorine-containing radicals, plasma, and ions. Further, although homogeneous reaction can be achieved by proceeding with these fluorination reactions in a solvent such as alcohol and mineral oil, fluorine can be introduced even when the solvent is not used.

### Example 2

A technique of subjecting a (Nd, Dy)₂Fe₁₄B sintered magnet containing 1 wt % of Dy to fluorination treatment to increase coercive force will be described in the present Example. Coercive force can be increased by selectively introducing only fluorine into a grain boundary without using a metal element in fluorination treatment followed by low temperature heat treatment, this technique allowing magnetic characteristics to be improved in a low temperature step of less than 600° C. without using a rare metal element. A mixture of hexane (C₆H₁₄) and XeF₂ (0.1 wt %) are used as a fluorinating agent. The XeF₂ is previously pulverized in an inert gas atmosphere to particles having an average particle size of 1000 μm or less, which is then mixed with hexane. A sintered magnet is inserted into the resulting mixture, and the both are put into a Ni container and heated. Heating temperature is 100° C., and fluorination proceeds at this temperature. A diffusion heat treatment with fluorine is performed without exposing the sintered magnet to atmospheric air after fluorination. Diffusion heat treatment temperature is set to a higher temperature range than the heating temperature. The sintered magnet is kept at a diffusion heat treatment temperature of 500° C. and then rapidly cooled. The coercive force is increased by the fluorination treatment and the diffusion heat treatment. The results are shown in No. 1 and No. 2 in Table 1-1.

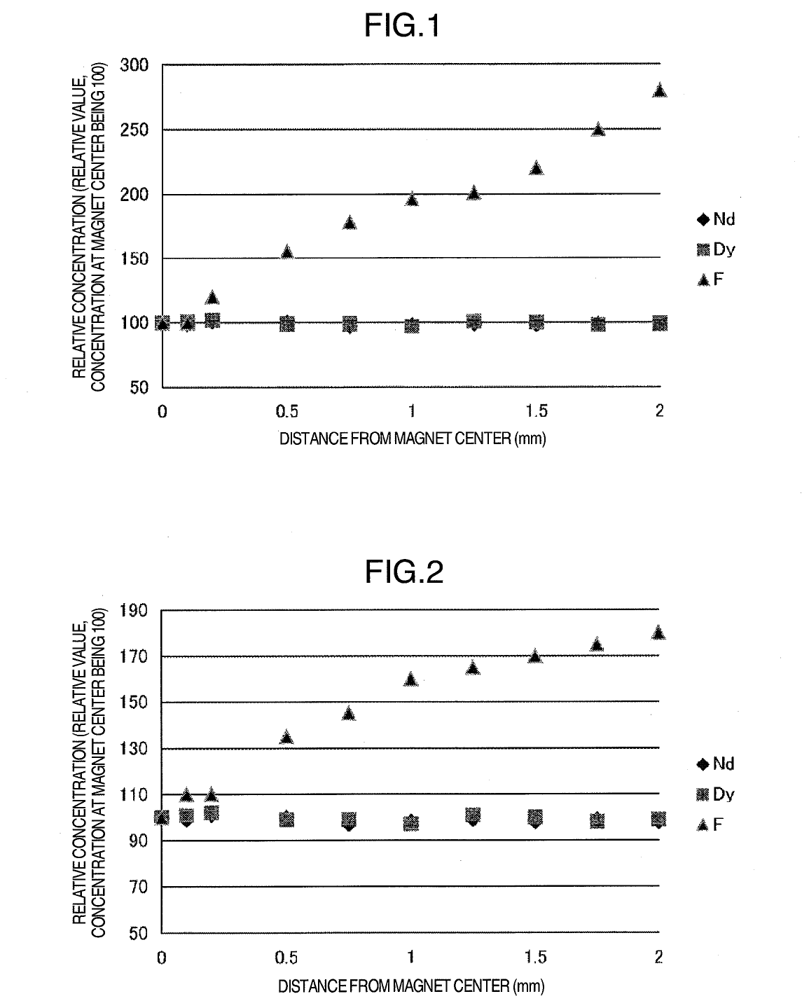

FIG. 1 shows the results of distributions of F, Nd, and Dy determined by mass spectrometry in the cross section of a sintered magnet having a thickness of 4 mm prepared under the conditions of No. 2 in Table 1-1. Although the concentrations of Nd and Dy are almost constant in the thickness direction, the concentration of F is higher at points closer to the surface (2 mm). It has been confirmed by electron beam diffraction using an electron microscope that an oxyfluoride is tetragonal and cubic in a region of 1.5 to 2 mm, and a tetragonal oxyfluoride increases at points closer to the surface.

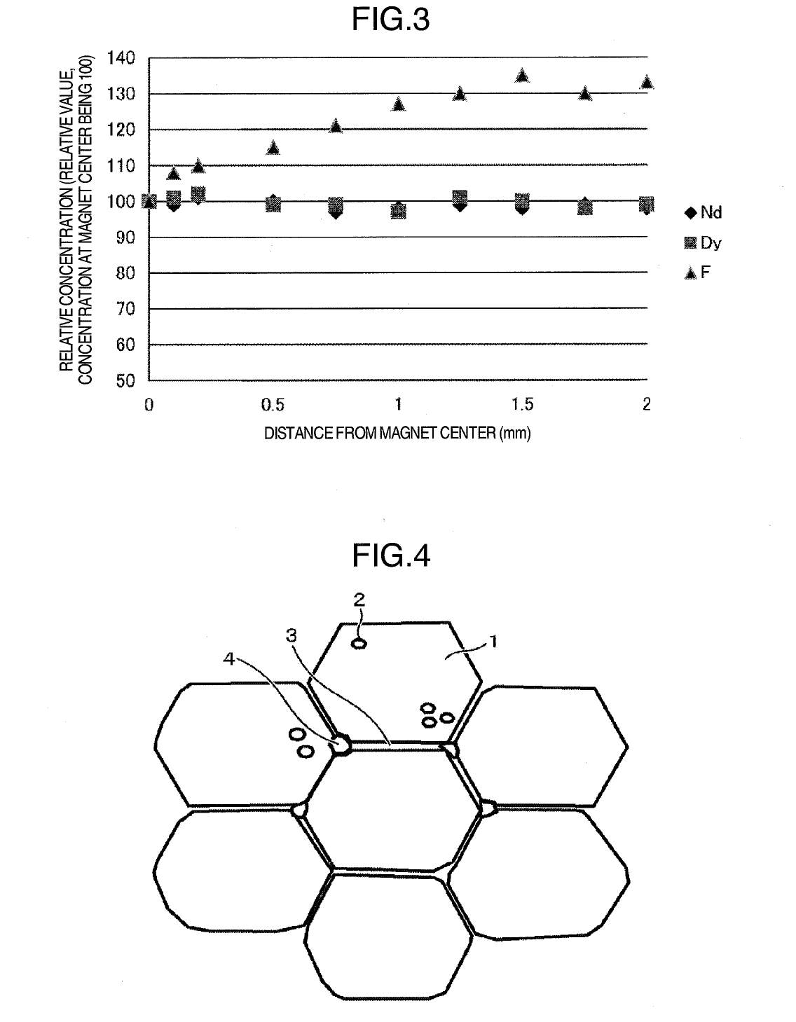

The diffusion heat treatment temperature is 500° C. in FIG. 1. When the diffusion heat treatment temperature is shifted to a higher temperature side of 550° C. or 600° C., the concentration distribution of fluorine changes as shown in FIG. 2 or FIG. 3, respectively. In the case of FIG. 1 and FIG. 2 in which a gradient is observed in the concentration of fluorine, the coercive force has increased by 024 MA/m than that of an untreated magnet. On the other hand, in the case of FIG. 3 in which the concentration gradient of the concentration of fluorine is not observed, the effect of increase in coercive force is as small as less than 0.1 MA/m.

FIG. 4 shows a typical structural view of the cross section of a sintered magnet after diffusion heat treatment at 500° C. A fluorine-containing phase in main phase 2 is observed in a crystal grain of a main phase crystal grain 1; a grain boundary phase 3 contains fluorine; and a fluorine-containing phase at grain boundary triple point 4 is observed at a part of grain boundary triple points. The concentration of fluorine in the grain boundary phase 3 or the fluorine-containing phase 4 at the grain boundary triple point is higher on the surface side of the sintered magnet than that in the inner part thereof, and the concentration of fluorine in the oxyfluoride in the range within 100 μm depthwise from the outermost surface (the outermost surface of the main phase) of the sintered magnet is higher than the concentration of oxygen.

Table 1-1 to Table 1-5 show the results of applying fluorination treatment to various materials to be treated, in which the values of magnetic characteristics before and after fluorination treatment are shown. It is found that the coercive force has increased from 2.00 MA/m to 2.10 MA/m under the above operation conditions. The magnet material in which an increase in coercive force by such fluorination treatment has been verified has features mainly in the following points.

1) An oxyfluoride of the cubic structure is formed in a rare-earth rich phase, and an oxyfluoride having a high concentration of fluorine (concentration of fluorine >33 atom %) grows in the vicinity of the surface of the magnet. When the concentration of fluorine is high, a tetragonal NdOₓF₃₋₂ₓ(0<x<1) grows. The concentration of fluorine in the oxyfluoride is distributed in the range of 10 to 70 atom %, and an average concentration of fluorine in the oxyfluoride of higher than 33 atom % in average in the vicinity of the surface within 100 μm from the outermost surface of the main phase crystal grain forms a composition suitable for the increase in coercive force. If the concentration of fluorine in the oxyfluoride exceeds 70 atom %, the structure of the oxyfluoride will be unstable, and the coercive force will also be reduced. 2) The concentration of fluorine tends to decrease depthwise from the surface of the magnet toward the inner part thereof, and since the treatment temperature is low, the concentration gradient is higher than the concentration gradients of other elements than fluorine. 3) The demagnetizing curve of the magnet before the diffusion treatment shows a curve, in which at least two types of demagnetizing curves of a low coercive force layer and a high coercive force layer are overlapped, but after the diffusion heat treatment, the shape of the demagnetizing curve changes, in which the low coercive force layer is integrated with the high coercive force layer. 4) If the diffusion heat treatment temperature is set to a higher temperature than 900° C., fluorine will be deposited at the grain boundary triple point and the like to partly produce an orthorhombic or hexagonal oxyfluoride different from the stable cubic structure, and uneven distribution of an additive element is relieved, thus reducing the coercive force. Therefore, the diffusion heat treatment temperature is preferably in a temperature range equal to fluorination treatment temperature or more and less than 900° C., and in the case of an NdFeB system, a temperature range of 200 to 800° C. is suitable.

Examples of a fluorination solution that can be applied other than the mixed solution (slurry, colloid, or pulverized powder-containing solution) of hexane and XeF₂ include combinations of various low-temperature dissociative fluorides and mineral oil and a combination of a fluoride that can generate a fluorine radical and mineral oil or an alcohol-based treatment solution. It is also possible to add a metal fluoride to a low-temperature dissociative fluoride or a fluorine radical-generating material to introduce and diffuse unevenly distributed elements from the surface during the fluorination treatment.

In the present Example, the magnetic characteristics will not be deteriorated even if a part of Xe is incorporated in the sintered magnet. Further, inevitably contained elements such as oxygen, nitrogen, carbon, hydrogen, sulfur, and phosphorus may be present. The (Nd, Dy)₂Fe₁₄B sintered magnet after the fluorination treatment may contain a carbide, an oxide, a nitride, and the like in addition to an oxyfluoride, a fluoride, a boride, and a Nd₂Fe₁₄B-based compound. Further, fluorine may substitute for the boron site of a (Nd, Dy)₂Fe₁₄B crystal, or may be located at any point between a rare earth element and an iron atom, between an iron atom and boron, and between a rare earth element and boron thereof.

As shown in Table 1-1 to Table 1-5, an increase in coercive force has been observed in various magnetic materials similar to (Nd, Dy)₂Fe₁₄B. An increase in coercive force can be observed even when a heavy rare earth element is not added, and a part of magnetization reversal sites is lost by the increase in interface anisotropy due to the growth of an oxyfluoride and introduction of a lattice strain in the vicinity of a grain boundary, the increase in anisotropy resulting from the change of the distribution of the electron density of states and the charge distribution of adjacent atoms by fluorine, the change of grain boundary composition, the change of the composition of a grain boundary surface and atomic arrangement, the increase in the ionic valence of a rare earth element, and the like.

As shown in Table 1-1 to Table 1-5, the magnetic characteristics is improved by the fluorination treatment using the dissociative fluorinating agent which is easily decomposed without additionally using of a rare earth element. The improvement effect of magnetic characteristics can be confirmed also for a Nd₂Fe₁₄B-based sintered magnet in which Dy is diffused in the grain boundary as shown in the results of No. 51 to No. 60 in Table 1-3. The temperature of fluorination treatment is low as shown in the Tables, and is preferably in the range of 50 to 400° C. in the case of the Nd₂Fe₁₄B-based sintered magnet. Since the dissociated fluorine is easily diffused and introduced into a rare earth-rich phase, the fluorination treatment can be performed at a lower temperature than conventional grain boundary diffusion treatment temperature.

As shown in Table 2, a fluorinated magnet of the present Example can be treated at a low temperature as compared with a conventional Dy vapor grain boundary diffusion magnet or a TbF-based grain boundary diffusion magnet, and an improvement in the magnetic characteristics such as coercive force can be achieved by the change of the composition structure of the grain boundary part by the introduction of fluorine. Therefore, the coercive force can be increased by using only the decomposable or dissociative fluorinating agent without using a rare earth element as a diffusing material to be added in the treatment. Fluorine introduced by the fluorination is easily bonded to oxygen or a rare earth element, and the addition of an element which easily forms a fluoride or an oxyfluoride such as MF₂, MF₃, and MOF (wherein M is an additive element other than a rare earth element, iron, boron, oxygen, and fluorine) leads to the improvement in magnetic characteristics.

### Example 3

A (Nd, Pr, Dy)₂Fe₁₄B sintered magnet is mixed with a XeF₂ pulverized powder, and the mixture is kept at 100° C. The average particle size of the XeF₂ pulverized powder is 100 μm. The XeF₂ pulverized powder is sublimated, and fluorination proceeds from the surface of the (Nd, Pr, Dy)₂Fe₁₄B sintered magnet. Fluorine is mainly introduced into a grain boundary where the content of Nd, Pr, Dy, and the like is high; an oxide turns into an oxyfluoride; and the composition and structure in the vicinity of the oxyfluoride is changed. After being kept at 100° C., the sintered magnet is kept at 450° C. to diffuse fluorine along the grain boundary and then rapidly cooled through a temperature range of 450 to 300° C. at a cooling rate of 10° C./second or more to increase coercive force. The coercive force before treatment is 1.5 MA/m, but the coercive force after diffusion/rapid cooling treatment is 2.1 MA/m.

The coercive force increase is based on the fluorine introduction step, and the coercive force can be increased even if a metal element such as a heavy rare earth element is not added. Introduction of fluorine turns an oxide or a rare earth-rich phase in the grain boundary into an oxyfluoride or a fluoride, in the vicinity of the surface of a sintered magnet. The oxyfluoride is a metastable cubic crystal, and a part of the elements which had been previously added to the sintered magnet is unevenly distributed in the vicinity of the grain boundary between the oxyfluoride and (Nd, Pr, Dy)₂Fe₁₄B.

Fluorine easily forms an oxyfluoride. When the concentration of oxygen is high, fluorine forms an oxyfluoride such as an orthorhombic, rhombohedral, hexagonal, triclinic, and monoclinic oxyfluoride other than a cubic and tetragonal fluorides, and uneven distribution of the additives becomes less remarkable. Therefore, the concentration of oxygen in a sintered magnet is preferably 3000 ppm or less, more preferably in the range of 100 to 2000 ppm. In order to remove oxygen in the vicinity of the surface, it is effective in the increase in coercive force to expose the sintered magnet to a reducing atmosphere before the fluorination or to advance the above fluorination treatment in the reducing atmosphere.

The XeF₂ mixed with the (Nd,Pr,Dy)₂Fe₁₄B sintered magnet is found to sublimate at 20° C., and a part thereof dissociates. Therefore, fluorination proceeds even at 100° C. or less. Although fluorine is introduced at a lower temperature than 50° C., an oxyfluoride is formed on the surface. The proportion of fluorine deposited on the surface as the oxyfluoride or the fluoride is higher than that of the fluorine diffused along the grain boundary, and it is difficult to diffuse fluorine into the inner part of the sintered magnet in the diffusion treatment after the fluorination treatment. Therefore, it is desirable to advance the fluorination treatment at 50 to 150° C. in the sintered magnet having a thickness of 1 to 5 mm.

The demagnetizing curve of the sintered magnet immediately after the fluorination treatment has an, inflection point in magnetic field that is 10 to 80% of the coercive force before the sintering, which is generally a stepped demagnetizing curve or a demagnetizing curve in which low coercive force components are overlapped. This is because the grain boundary width has been extended by the introduction of fluorine, and a part of the surface of the main phase crystal grain has been fluorinated. With respect to such demagnetizing curve, the stepped demagnetizing curve or the demagnetizing curve in which low coercive force components are overlapped is changed to a curve similar to the demagnetizing curve before the fluorination treatment by the next diffusion and aging heat treatment, thus increasing the coercive force. The diffusion and aging heat treatment depend on grain boundary (grain boundary triple point and two-grain boundary) composition, main phase composition, particle size, the type of additives, the content of impurities such as oxygen, orientation, crystal grain shape, and directional relationships between crystal grains and between a crystal grain and a grain boundary.

In order to obtain larger coercive force than the coercive force before the fluorination treatment, the diffusion heat treatment temperature after the fluorination treatment needs to be 800° C. or less. If the temperature exceeds 800° C., the interface between oxyfluoride/main phase will decrease, and fluorine is easily concentrated at the grain boundary triple point. Thus, an interface between a phase having a low concentration of fluorine such as oxyfluoride/oxide/main phase and the main phase increases; a part of uneven distributions of additives by fluorine disappears; and the effect of increase in coercive force is reduced. Therefore, the highest keeping temperature of diffusion heat treatment temperature is preferably 300 to 800° C.

The following features have been observed in the sintered magnet of the present Example as compared with conventional magnets. 1) An oxyfluoride in which the concentration of fluorine in the grain boundary is higher than the concentration of oxygen is formed, and the concentration gradient of fluorine is observed from the surface of the sintered magnet toward the inner part thereof 2) ReOF₁₊ₓ(where Re represents a rare earth element; O represents oxygen; F represents fluorine; and X represents a positive number) in which the concentration of fluorine is higher than that in ReOF is formed in a part of the grain boundary. 3) The structure of the oxyfluoride is mainly the cubic structure, and may additionally include an amorphous, orthorhombic, rhombohedral, tetragonal, and hexagonal structures. 4) A fluorine-containing phase is observed in a part of the main phase crystal grain, and the volume fraction of the fluorine-containing phase decreases from the surface of the sintered magnet toward the inner part thereof. 5) Fluorine is introduced into the grain boundary, and an element which is easily bonded to fluorine is diffused to the periphery side of the main phase or the grain boundary, thus increasing the saturation magnetization of the main phase.

A technique of increasing coercive force while maintaining residual magnetic flux density, such as a technique of increasing a coercive force of 1.5 MA/m to a coercive force of 2.1 MA/m after the fluorination treatment and the diffusion rapid cooling treatment as described in the present Example, can be achieved by introducing a halogen element other than fluorination. An additive element which easily forms a halide is selected and previously added in a dissolution step before sintering. The mixture can be sintered to unevenly distribute the additive element after halogenation treatment. It is also possible to increase the coercive force by applying halogenation treatment to a temporary molded product after temporary molding in a magnetic field to unevenly distribute the halogen element and the additive element into the vicinity of a liquid phase after sintering.

### Example 4

Fe nanoparticles are prepared by a wet method, and then the solvent is changed to a mixed slurry of XeF₂ and an alcohol without drying. The resulting mixture is heated in a nitrogen atmosphere. The nanoparticles have an average particle size of 30 nm. The fluorination treatment temperature was set at 150° C. After fluorination, the nanoparticles were inserted into a molding die in magnetic field and subjected to compression molding after applying a magnetic field of 0.1 MA/m. The resulting molded product was heated in a NH₃ atmosphere to subject it to a nitriding treatment.

The magnet prepared has magnetic characteristics of a residual magnetic flux density of 1.6 T and a coercive force of 1.5 MA/m. When Fe₁₆(N, F)₂ of a tetragonal structure grows in the Fe nanoparticles, and the concentration of fluorine is higher than nitrogen concentration/2, the coercive force will increase. Anisotropy is generated in the distribution of the electron density of states of iron atoms by introducing fluorine, which changes magnetic moment and a crystal field parameter, thereby increasing magnetocrystalline anisotropy. A metastable magnet material can be provided by insuring lattice stability by nitrogen and by the effect of increasing magnetic anisotropy by fluorine. When the concentration of nitrogen is 4 atom %, the coercive force increases to 0.5 MA/m or more at a concentration of fluorine of 2 to 7 atom %.

A super lattice in which fluorine and nitrogen are introduced into a FeCo super lattice to form a bct structure can be formed by subjecting FeCo nanoparticles to the fluorination and nitriding treatment under the conditions as described above. The c/a of this super lattice is 1.03 to 1.2, and fluorine atoms are orderly arranged in the c axial direction. In order to correct the imbalance of electronegativity by the introduction of fluorine, 0.0001 to 0.01 atom % of holes are introduced. The FeCoFN-based bet structure crystal having an ordered structure including the holes has a saturation magnetization of 250 Am²/kg and a coercive force of 1.8 MA/m, and a high-performance magnet is obtained by molding at a decomposition temperature or less. An element which serves as a positive charge instead of holes may be arranged. In order to increase decomposition temperature, 0.1 to 10 atom % of at least one element selected from Al, Ti, Ga, and the like serving as an element to form a fluoride and a nitride is added. Thereby, the decomposition temperature will be 450° C. If the above additive element and rare earth element are added, the decomposition temperature can be increased to 500° C. or more.

An FeMNF-based compound (where Fe represents iron; M represents an additive element; N represents nitrogen; and F represents fluorine) in which fluorine is introduced is a super lattice of a bct structure as described in the present Example. The degree of order is increased by introducing fluorine followed by suitable heat treatment, and coercive force is also increased. When the degree of order of a perfect super lattice is 1.0, a FeMNF-based compound having a degree of order in the range of 0.1 to 0.99 can be formed. When the concentration of fluorine is 2 to 7 atom % and the coercive force is 0.5 MA/m or more, the degree of order is in the range of 0.3 to 0.99. Note that there is no particular problem even if orthorhombic, hexagonal, rhombohedral, and cubic structures are mixed in addition to the bet structure.

### Example 5

A Nd₂Fe₁₄B sintered magnet having an average particle size of a main phase of 1.5 μm is immersed in an alcoholic solution mixed with a XeF₄ powder and heated to 120° C. at a heating rate of 10° C./min followed by keeping the mixture at the same temperature. The XeF₄ powder decomposes during heating, and the Nd₂Fe₁₄B sintered magnet is fluorinated. Xe does not react with the Nd₂Fe₁₄B sintered magnet, but only fluorine is mainly introduced into the Nd₂Fe₁₄B sintered magnet. The amount of fluorine to be introduced is 0.001 to 5 atom %, which depends on the volume and a surface state of the Nd₂Fe₁₄B sintered magnet and fluorination treatment conditions. The introduction of fluorine can be determined by verifying an oxyfluoride and a fluoride by mass spectrometry, wavelength dispersive x-ray spectrometry, and structural analysis. When the amount of fluorine introduced is insufficient, the amount can be adjusted by increasing the time for retreatment in the alcohol-based solution.

After fluorine is introduced, the fluorine is diffused into the inner part of the Nd₂Fe₁₄B sintered magnet by an aging heat treatment to increase coercive force. The formation of a cubic oxyfluoride can be observed when the magnet is heated to 400° C. at 5° C./min, kept at 400° for 1 hour, and then rapidly cooled. The magnet is preferably cooled through the Curie temperature at a rapid cooling rate of 10 to 200° C./min. A rare earth-rich phase or a rare earth oxide in a grain boundary is fluorinated to a higher degree than the main phase, and the coercive force is increased to a higher level than that of an untreated Nd₂Fe₁₄B sintered magnet by the diffusion by the aging heat treatment and by controlling the structure and composition distribution of a grain boundary phase. The amount of increase is larger than in the case of using a slurry or an alcoholic swelling solution of a rare earth fluoride or a metal fluoride, or in the case of fluorination with a fluorine-containing gas (such as F₂ and NHF₄), and an increase in coercive force of 0.1 to 5 MA/m can be observed.

If the amount of fluorine exceeds 5 atom %, the crystal of the main phase will be decomposed by fluorine that entered the main phase of the Nd₂Fe₁₄B sintered magnet, and a ferromagnetic phase having a small coercive force will be formed. This increases residual magnetic flux density, but leads to reduction in the temperature dependence of coercive force or reduction in the square shape properties of a demagnetizing curve. Therefore, the amount of fluorine to be introduced is preferably 5 atom % or less, and is preferably 10 atom % or less in a part from the surface toward a depth of 100 μm. The concentration of fluorine in the grain boundary phase or the grain boundary triple point may be 5 atom % or more. In the case where an NdOF-based oxyfluoride has been formed, an increase in coercive force of the Nd₂Fe₁₄B sintered magnet will be more remarkable when the concentration of fluorine is higher than the oxygen concentration.

The oxyfluoride formed is represented by ReₓO_{y}F_{z} (where Re represents a rare earth element; O represents oxygen; F represents fluorine; and x, y, and z each represent a positive number), and a compound in which y<z grows in the grain boundary at a higher volume fraction than a compound in which y≧z. For example, fluorine content is higher than oxygen content by local analysis even if the oxyfluoride has a crystal structure of NdOF. Further, oxygen is detected by local analysis even in a fluorine compound such as NdF₂ and NdF₃, and it can be analyzed that the concentration of oxygen < the concentration of fluorine. A layer in which the concentration of fluorine is higher than the concentration of oxygen is formed by the fluorination treatment in the grain boundary phase having a rare earth-rich composition. Such a distribution of the concentration of fluorine is different between the surface and the central part of the sintered magnet, and the concentration of fluorine tends to decrease toward a position which is away from the fluorinated surface.

The composition of planes parallel to the surface of the sintered magnet was analyzed in an area of 0.1×0.1 mm² at depths of 0.1 mm and 1 mm (planes parallel to the surface), and the composition was found to be almost the same. However, when the sintered magnet was subjected to a fluorination treatment, only fluorine differed in composition, and the concentration of elements other than fluorine was found to be almost the same in an area of 0.1×0.1 mm² at depths of 0.1 mm and 1 mm (planes parallel to the surface). The local distribution of the composition in the grain boundary, the grain boundary triple point, and the vicinity of a different phase in the grain is different in an area of 0.1×0.1 mm² at depths of 0.1 mm and 1 mm (planes parallel to the surface). That is, the distribution of the composition in an interface between a different phase which differs in a crystal structure or composition from a main phase and the main phase and in a region within 100 nm from the interface is changed by fluorination treatment.

By the fluorination treatment, a part of additive elements contained in the main phase is unevenly distributed in the interface of a fluoride or an oxyfluoride and in the vicinity (within 100 nm) of the interface, and the magnetic properties of the main phase in the vicinity of the interface, the interface, and the grain boundary phase are changed. An element that is easily bonded to fluorine, an element that stabilizes the fluoride or the oxyfluoride, an element that returns the imbalance of electronegativity by fluorination, holes, and the like gather in the vicinity of the interface. As a result, local magnetic properties of the main phase change, leading to the increase in coercive force.

Further, a Nd-containing oxyfluoride is more stable than an oxyfluoride of Dy or Tb due to the difference of the free energy for the elements of a fluoride or an oxyfluoride by the introduction of fluorine, and the composition of the grain boundary phase is changed by the introduction of fluorine.

A fluorinating agent for the introduction of fluorine is preferably a material containing an inert gas element and fluorine as described in the present Example. Such a material allows easy introduction of fluorine at a lower temperature than the temperature of fluorination with the fluorine (F₂) gas or the fluoride such as ammonium fluoride (NH₄F) and a rare earth fluoride. It is possible to fluorinate a sintered magnet material at a low temperature using a slurry or a colloidal solution in which a material containing an inert gas element and fluorine is mixed with an alcohol or mineral oil; or a mixture of a material containing an inert gas element and fluorine with a fluorine (F₂) gas; or a mixed and dispersed solution, a mixed slurry, or a mixed alcohol swelling liquid of a material containing an inert gas element and fluorine with a fluoride such as ammonium fluoride (NH₄F) and a rare earth fluoride or an oxyfluoride; or a solution in which a material containing an inert gas element and fluorine has gelled or solated.

### Example 6

Fe nanoparticles having a particle size of about 30 nm are prepared by a wet method, and then the solvent is replaced by an alcohol containing NH₃ and XeF₂ without drying.

The resulting mixture is heated to 120° C. and kept at the same temperature. Fluorine (F) and nitrogen (N) are diffused into the nanoparticles by heating to grow Fe₄(F, N). The nanoparticles are cooled to 20° C., formed in a magnetic field, and bound by using an organic or an inorganic binder, thus forming a magnet material.

The resulting Fe₄(F, N) has a composition of Fe-5 atom % F-15 atom % N and forms an ordered lattice in which nitrogen and fluorine are located at the same atom positions. An easy magnetization direction is parallel to the direction in which a large number of fluorine atoms are arranged, and the magnet material has uniaxial crystal magnetic anisotropy. The arrangement of fluorine is further promoted by applying a magnetic field during the reaction, and the introduction of a tetragonal structure or a lattice strain is observed.

The Fe₄(F, N) of a tetragonal structure has a residual magnetic flux density of 1.5 T and a coercive force of 0.8 MA/m and can be applied as a low cost bond magnet in which a rare earth element is not used. Such an effect of increasing the magnetic anisotropy by fluorine utilizes the large electronegativity of fluorine. The anisotropy is added to the distribution of the electron density of states around an iron atom by the property that fluorine attracts shared electrons and carries partial charge. Such a partial charge effect can be realized by introducing fluorine into other iron-based crystals, allowing the position of fluorine atoms to be ordered, and forming a direction in which a large number of fluorine atoms are arranged, and can be achieved by a compound containing any one of oxygen, sulfur, arsenic, phosphorus, and silicon, such as perovskite.

The anisotropic arrangement of fluorine can be observed in the anisotropic arrangement of fluorine atoms in a layer compound such as an intercalation compound, or the anisotropic arrangement in a polycrystalline material which has undergone spinodal decomposition, in addition to the anisotropic difference of the number of positions of fluorine atoms in the ordered lattice as described in the present Example. When the difference in the concentration of fluorine is 5% or more between the direction in which a large number of fluorine atoms are arranged and the direction in which a small number of fluorine atoms are arranged, magnetic anisotropy will also be observed. In order to obtain an anisotropy magnetic field of 1 MA/m or more, it is effective in an iron-based material to set the difference in the concentration of fluorine to 10% or more, preferably 10% or more and 99% or less. Although 99% or more is ideal in design, it is difficult to achieve because the heat treatment accompanied by diffusion is performed at 100° C. or more. Therefore, the difference in the concentration of fluorine by the direction, the bias of charge and polarization, or the difference in the direction of ion binding properties by the introduction of fluorine can be prepared in a range of 10 to 99%, thus in this range, a material is formed in which magnetic anisotropy is observed and which is suitable for a magnet material.

If the concentration of fluorine is higher than that of carbon and oxygen which are mixed as impurities, the effect of fluorine will be observed depending on the arrangement of fluorine. In order to obtain a coercive force of 0.5 MA/m or more, fluorine is preferably contained in an amount of at least 0.1 atom % of the whole magnet material. If the content of fluorine exceeds 20 atom %, a stable fluoride and oxyfluoride grow to thereby reduce magnetization. Therefore, the range of 0.1 to 20 atom % is the optimum.

Examples of fluorinating agents that can be used other than XeF₂ include XeOF₄, KrF₂, Kr₂F₃, ArF, KHF₂, SF₆, TeF₆, NF₃, CF₄, CIF, CIF₃, BrF, BrF₃, BrF₅, IF₅, and IF₇,

TABLE 1-1

| | | | Particle size | | | | Residual | |
|---|---|---|---|---|---|---|---|---|
| | | | of fluoride in | | Diffusion heat | | magnetic | |
| | | | treatment | Treatment | treatment | Coercive | flux | |
| | Material | Main components in | solution | temperature | temperature | force | density | |
| No. | to be treated | treatment solution | (μm) | (° C.) | (° C.) | (MA/m) | (T) | Remarks |
| 1 | (Nd,Dy)₂Fe₁₄B | — | — | — | — | 2.00 | 1.40 | Values before |
| | | | | | | | | treatment in |
| | | | | | | | | No. 2-14 |
| 2 | (Nd,Dy)₂Fe₁₄B | Hexane(C₆H₁₄), XeF₂ (0.1 wt %) | <1000 | 100 | 500 | 2.24 | 1.40 | |
| 3 | (Nd,Dy)₂Fe₁₄B | Hexane(C₆H₁₄), XeF₂ (0.1 wt %) | <100 | 100 | 500 | 2.20 | 1.41 | |
| 4 | (Nd,Dy)₂Fe₁₄B | Hexane(C₆H₁₄), XeF₂ (0.1 wt %) | <10 | 100 | 500 | 2.35 | 1.41 | |
| 5 | (Nd,Dy)₂Fe₁₄B | Hexane(C₅H₁₄), XeF₂ (0.5 wt %) | <10 | 100 | 500 | 2.52 | 1.42 | |
| 6 | (Nd,Dy)₂Fe₁₄B | Hexane(C₆H₁₄), XeF₂ (1.0 wt %) | <10 | 150 | 450 | 2.68 | 1.45 | |
| 7 | (Nd,Dy)₂Fe₁₄B | Heptane(C₇H₁₆), XeF₂ (1.0 wt %) | <10 | 150 | 450 | 2.74 | 1.45 | |
| 8 | (Nd,Dy)₂Fe₁₄B | Heptane(C₇H₁₆), XeF₂ (5.0 wt %) | <10 | 150 | 440 | 2.83 | 1.51 | |
| 9 | (Nd,Dy)₂Fe₁₄B | Hexane(C₅H₁₄), XeF₂ (0.1 wt %), | <10 | 100 | 500 | 2.43 | 1.42 | |
| | | Co complex (β-diketone) (0.1 wt %) | | | | | | |
| 10 | (Nd,Dy)₂Fe₁₄B | Hexane(C₈H₁₄), XeF₂ (0.1 wt %), | <10 | 100 | 500 | 2.65 | 1.40 | |
| | | Ga complex (β-diketone) (0.1 wt %) | | | | | | |
| 11 | (Nd,Dy)₂Fe₁₄B | Hexane(C₈H₁₄), XeF₂ (0.1 wt %), | <100 | 100 | 500 | 2.35 | 1.39 | |
| | | SnF₂ (0.1 wt %) | | | | | | |
| 12 | (Nd,Dy)₂Fe₁₄B | Hexane(C₆H₁₄), XeF₂ (0.1 wt %), | <10 | 100 | 500 | 2.45 | 1.38 | |
| | | DyF₃ (0.01 wt %) | | | | | | |
| 13 | (Nd,Dy)₂Fe₁₄B | Hexane(C₅H₁₄), XeF₂ (0.1 wt %), | <10 | 100 | 500 | 2.38 | 1.36 | |
| | | DyOF (0.01 wt %) | | | | | | |
| 14 | (Nd,Dy)₂Fa₁₄B | Hexane(C₆H₁₄), XeF₂ (0.1 wt %), | <10 | 100 | 500 | 2.82 | 1.38 | |
| | | TbF₃ (0.01 wt %) | | | | | | |
| 15 | Nd₂Fe₁₄B | — | — | — | — | 1.20 | 1.53 | Values before |
| | | | | | | | | treatment in |
| | | | | | | | | No. 16-50 |
| 16 | Nd₂Fe₁₄B | Hexane(C₆H₁₄), XeF₂ (0.5 wt %) | <10 | 100 | 500 | 1.85 | 1.55 | |
| 17 | Nd₂Fe₁₄B | Hexane(C₆H₁₄), XeF₃ (0.5 wt %) | <10 | 100 | 500 | 1.88 | 1.55 | |
| 18 | Nd₂Fe₁₄B | Hexane(C₆H₁₄), XeF₄ (0.5 wt %) | <10 | 100 | 500 | 1.92 | 1.54 | |
| 19 | Nd₂Fe₁₄B | Hexane(C₉H₁₄), XeF₆(0.5 wt %) | <10 | 100 | 500 | 2.03 | 1.55 | |
| 20 | Nd₂Fe₁₄B | Hexane(C₆H₁₄), XeF₈(0.5 wt %) | <10 | 100 | 500 | 2.08 | 1.55 | |
| 21 | Nd₂Fe₁₄B | Hexane(C₆H₁₄), Xe₂F₃ (0.5 wt %) | <10 | 100 | 500 | 2.15 | 1.55 | |
| 22 | Nd₂Fe₁₄B | Hexane(C₆H₁₄), XeOF₄ (0.5 wt %) | <10 | 100 | 500 | 1.89 | 1.55 | |
| 23 | Nd₂Fe₁₄B | Hexane(C₆H₁₄), XeF (0.5 wt %) | <10 | 100 | 500 | 1.82 | 1.55 | |

TABLE 1-2

| | | | Particle size | | | | Residual | |
|---|---|---|---|---|---|---|---|---|
| | | | of fluoride in | | Diffusion heat | | magnetic | |
| | | | treatment | Treatment | treatment | Coercive | flux | |
| | Material | | solution | temperature | temperature | force | density | |
| No. | to be treated | Main components in treatment solution | (μm) | (° C.) | (° C.) | (MA/m) | (T) | Remarks |
| 24 | Nd₂Fe₁₄B | Hexane(C₆H₁₄), XeF₂ (0.5 wt %), | <10 | 100 | 500 | 1.97 | 1.55 | |
| | | XeF (0.5 wt %) | | | | | | |
| 25 | Nd₂Fe₁₄B | Hexane(C₆H₁₄), SbF₄ (0.5 wt %) | <10 | 100 | 500 | 1.95 | 1.55 | |
| 26 | Nd₂Fe₁₄B | Hexane(C₆H₁₄), XeF₂ (0.5 wt %), | <10 | 100 | 500 | 1.91 | 1.55 | |
| | | ClF (0.5 wt %) | | | | | | |
| 27 | Nd₂Fe₁₄B | Hexane(C₆H₁₄), BrF(0.5 wt %) | <10 | 100 | 500 | 1.91 | 1.55 | |
| 28 | Nd₂Fe₁₄B | Hexane(C₆H₁₄), SiF₂ (0.5 wt %) | <10 | 100 | 500 | 1.89 | 1.53 | |
| 29 | Nd₂Fe₁₄B | Hexane(C₆H₁₄), SiF₄ (0.5 wt %) | <100 | 100 | 500 | 2.35 | 1.53 | |
| 30 | Nd₂Fe₁₄B | Hexane(C₆H₁₄), HBF₄ (0.5 wt %) | <100 | 100 | 500 | 2.35 | 1.52 | |
| 31 | Nd₂Fe₁₄B | Hexane(C₆H₁₄), SF₄ (0.5 wt %) | <100 | 100 | 500 | 2.35 | 1.53 | |
| 32 | Nd₂Fe₁₄B | Methanol(CH₃OH), Al₂F₁₂ (0.1 wt %) | <100 | 150 | 500 | 1.35 | 1.54 | |
| 33 | Nd₂Fe₁₄B | Methanol(CH₃OH), Al₃F₁₆ (0.1 wt %) | <100 | 100 | 500 | 1.38 | 1.53 | |
| 34 | Nd₂Fe₁₄B | Methanol(CH₃OH), Al₄F₂₀ (0.1 wt %) | <100 | 100 | 500 | 1.42 | 1.53 | |
| 35 | Nd₂Fe₁₄B | Methanol(CH₃OH), Al₅F₂₆ (0.1 wt %) | <100 | 100 | 500 | 1.48 | 1.54 | |
| 36 | Nd₂Fe₁₄B | Methanol(CH₃OH), Al₇F₃₀ (0.1 wt %) | <100 | 100 | 500 | 1.58 | 1.53 | |
| 37 | Nd₂Fe₁₄B | Methanol(CH₃OH), Al₈F₃₉ (0.1 wt %) | <100 | 100 | 500 | 1.61 | 1.54 | |
| 38 | Nd₂Fe₁₄B | Methanol(CH₃OH), CF₄ (0.1 wt %) | <100 | 100 | 500 | 1.31 | 1.53 | |
| 39 | Nd₂Fe₁₄B | Methanol(CH₃OH), C₃F₈ (0.1 wt %) | <100 | 100 | 500 | 1.29 | 1.55 | |
| 40 | Nd₂Fe₁₄B | Methanol(CH₃OH), C₄F₈ (0.1 wt %) | <100 | 100 | 500 | 1.34 | 1.54 | |
| 41 | Nd₂Fe₁₄B | Methanol(CH₃OH), CaAlF₅ (0.1 wt %) | <100 | 100 | 500 | 1.58 | 1.53 | |
| 42 | Nd₂Fe₁₄B | Methanol(CH₃OH), BaAlF₅ (0.1 wt %) | <100 | 100 | 500 | 1.75 | 1.53 | |
| 43 | Nd₂Fe₁₄B | Methanol(CH₃OH), Ba₃AlF₉ (0.1 wt %) | <100 | 100 | 500 | 1.78 | 1.53 | |
| 44 | Nd₂Fe₁₄B | Methanol(CH₃OH), Na₆Al₂F₁₄ (0.1 wt %) | <100 | 100 | 500 | 1.95 | 1.53 | |
| 45 | Nd₂Fe₁₄B | Methanol(CH₃OH), CCl₂F₂ (0.1 wt %) | <100 | 100 | 500 | 1.35 | 1.55 | |
| 46 | Nd₂Fe₁₄B | Methanol(CH₃OH), CClF₂(0.1 wt %) | <100 | 100 | 500 | 1.36 | 1.56 | |
| 47 | Nd₂Fe₁₄B | Methanol(CH₃OH), KAlF₄ (0.1 wt %) | <100 | 100 | 500 | 1.42 | 1.53 | |
| 48 | Nd₂Fe₁₄B | Methanol(CH₃OH), K₃AlF₅ (0.1 wt %) | <100 | 100 | 500 | 1.39 | 1.53 | |
| 49 | Nd₂Fe₁₄B | C₆H₁₄), NH₄HF (0.5 wt %) | <100 | 100 | 500 | 1.52 | 1.53 | |

TABLE 1-3

| | | | Particle size of | | Diffusion heat | | Residual | |
|---|---|---|---|---|---|---|---|---|
| | | | fluoride in | Treatment | treatment | | magnetic | |
| | | | treatment solution | temperature | temperature | Coercive force | flux density | |
| No. | Material to be treated | Main components in treatment solution | (μm) | (° C.) | (° C.) | (MA/m) | (T) | Remarks |
| 55 | Nd₂Fe₁₄B | Hexane(C₆H₄),C₆F₆(0.5 wt %) | <100 | 100 | 500 | 1.55 | 1.53 | |
| 51 | Nd₂Fe₁₄B in which Dy is | — | — | — | — | 1.85 | 1.50 | Values before treatment in No. 52-60 |
| | diffused in grain boundary | | | | | | | |
| 52 | Nd₂Fe₁₄B in which Dy is | Hexane(C₆H₄), SnF₂ (0.1 wt %) | <10 | 120 | 450 | 1.84 | 1.48 | |
| | diffused in grain boundary | | | | | | | |
| 53 | Nd₂Fe₁₄B in which Dy is | Hexane(C₆H₄), XeF₂ (0.1 wt %) | <10 | 100 | 500 | 1.93 | 1.50 | |
| | diffused in grain boundary | | | | | | | |
| 54 | Nd₂Fe₁₄B in which Dy is | Hexane(C₆H₄), XeF₂ (0.5 wt %) | <10 | 100 | 500 | 2.01 | 1.51 | |
| | diffused in grain boundary | | | | | | | |
| 55 | Nd₂Fe₁₄B in which Dy is | Hexane(C₆H₄), XeF₂ (0.5 wt %), | <10 | 120 | 500 | 1.92 | 1.54 | |
| | diffused in grain boundary | ClF (0.5 wt %) | | | | | | |
| 56 | Nd₂Fe₁₄B in which Dy is | Hexane(C₆H₄), XeF₂ (0.1 wt %), | <10 | 120 | 500 | 2.31 | 1.55 | |
| | diffused in grain boundary | GaF₃ (0.01 wt %) | | | | | | |
| 57 | Nd₂Fe₁₄B in which Dy is | Hexane(C₆H₄), XeF₂ (0.1 wt %), | <10 | 120 | 500 | 2.26 | 1.56 | |
| | diffused in grain boundary | TiF₃ (0.01 wt %) | | | | | | |
| 58 | Nd₂Fe₁₄B in which Dy is | Methanol(CH₃OH), XeF₂ (0.1 wt %) | <100 | 80 | 450 | 1.86 | 1.50 | |
| | diffused in grain boundary | | | | | | | |
| 59 | Nd₂Fe₁₄B in which Dy is | Ethanol(C₂H₃OH), XeF₂ (0.1 wt %) | <100 | 80 | 450 | 1.87 | 1.50 | |
| | diffused in grain boundary | | | | | | | |
| 60 | Nd₂Fe₁₄B in which Dy is | Ethanol(C₂H₃OH), XeF₂ (0.1 wt %), | <100 | 70 | 450 | 1.95 | 1.50 | |
| | diffused in grain boundary | GaF₃ (0.01 wt %) | | | | | | |
| 61 | Fe—24% Co14% Ni3% Cu9.2% Ti | — | — | — | — | 0.06 | 1.34 | Values before treatment in No. 62 |
| 62 | Fe—24% Co14% Ni3% Cu9.2% Ti | Hexane(C₆H₄), XeF₂ (0.1 wt %) | <1000 | 120 | 500 | 0.93 | 1.33 | |
| 63 | Fe—15% Co1.0% Ti24% Cr | — | — | — | — | 0.06 | 1.50 | Values before treatment in No. 64 |
| 64 | Fe—15% Co1.0% Ti24% Cr | Hexane(C₆H₄), XeF₂ (0.1 wt %) | <1000 | 120 | 500 | 0.95 | 1.48 | |
| 65 | BeO—6Fe₂O₃ | — | — | — | — | 0.21 | 0.41 | Values before treatment in No. 66 |
| 66 | BeO—6Fe₂O₃ | Hexane(C₆H₄), XeF₂ (0.1 wt %) | <1000 | 90 | 800 | 0.34 | 0.55 | |
| 67 | SrO—6Fe₂O₃ | — | — | — | — | 0.28 | 0.42 | Values before treatment in No. 68 |
| 68 | SrO—6Fe₂O₃ | Hexane(C₆H₄), XeF₂ (0.1 wt %) | <1000 | 80 | 700 | e.35 | 0.53 | |
| 69 | Sr_{0.7}La_{0.3}Fe₁₁₇Co₀₃O₁₉ | — | — | — | — | 0.38 | 0.45 | Values before treatment in No. 70-71 |
| 70 | Sr_{0.7}La₀₃Fe₁₁₇Co₀₃O₁₉ | Hexane(C₆H₄), XeF₂ (0.1 wt %) | <100 | 150 | 900 | 0.55 | 0.52 | |
| 71 | Sr_{0.7}La₀₉Fe₁₁₇Co₀₃O₁₉ | Heptane(C₇H₁₆), XeF₂(5.0 wt %) | <10 | 140 | 700 | 0.63 | 0.56 | |
| 72 | Sm(Co_{0.69}Fe_{0.20}Cu_{0.10}Zr_{0.01})_{7.4} | — | — | — | — | 0.55 | 1.10 | Values before treatment in No. 73 |
| 73 | Sm(Co_{0.69}Fe_{0.20}Cu_{0.10}Zr_{0.01})_{7.4} | Hexane(C₆H₄), XeF₂ (0.1 wt %) | <1000 | 80 | 700 | 1.12 | 1.11 | |

TABLE 1-4

| | | | Particle size | | Diffusion heat | | | |
|---|---|---|---|---|---|---|---|---|
| | | | of fluoride | Treatment | treatment | Coercive | Residual magnetic | |
| | | | in treatment solution | temperature | temperature | force | flux density | |
| No. | Material to be treated | Main components in treatment solution | (μm) | (° C.) | (° C.) | (MA/m) | (T) | Remarks |
| 74 | Y₂Fe₁₄B | — | — | — | — | 0.75 | 1.32 | Values before treatment in No. 75 |
| 75 | Y₂Fe₁₄B | Hexane, XeF₂ (0.5 wt %) | <100 | 100 | 510 | 0.87 | 1.41 | |
| 76 | Mn—30% Al0.5% C | — | — | — | — | 0.22 | 0.60 | Values before treatment in No. 77-79 |
| 77 | Mn—30% Al0.5% C | Hexane(C₆H₁₄), XeF₂ (0.1 wt %) | <1000 | 80 | 700 | 0.53 | 0.73 | |
| 78 | Mn—30% Al0.5% C | Hexane(C₆H₁₄), XeF₂ (0.01 wt %) | <10 | 120 | 600 | 0.54 | 0.76 | |
| 79 | Mn—30% Al0.5% C | Hexane(C₆H₁₄), XeF₂ (0.01 wt %), | <10 | 130 | 550 | 0.73 | 0.81 | |
| | | NH₂ (0.5 wt %) | | | | | | |
| 80 | Fe—50% Co | — | — | — | — | 0.05 | 1.90 | Values before treatment in No.81-85 |
| 81 | Fe—50% Co | Hexane(C₆H₁₄), XeF₂ (0.1 wt %) | <1000 | 80 | 700 | 0.95 | 1.91 | |
| 82 | Fe—50% Co | Heptane(C₇H₁₄), XeF₂ (5.0 wt %) | <100 | 100 | 500 | 1.36 | 1.92 | |
| 83 | Fe—50% Co | Heptane(C₇H₁₄), XeF₄ (5.0 wt %) | <10 | 140 | 500 | 1.57 | 1.95 | |
| 84 | Fe—50% Co | Heptane(C₇H₁₄), XeF₄ (5.0 wt %), | <10 | 140 | 500 | 1.72 | 1.87 | |
| | | TbF₃ (0.01 wt %) | | | | | | |
| 85 | Fe—50% Co | Heptane(C₇H₁₄), SnF₂ (5.0 wt %) | <10 | 160 | 450 | 1.15 | 1.75 | |
| 86 | Fe—25% Co | — | — | — | — | 0.05 | 1.97 | Values before treatment in No. 87-88 |
| 87 | Fe—25% Co | Hexane(C₆H₁₄), XeF₂ (0.1 wt %) | <1000 | 90 | 700 | 0.87 | 2.02 | |
| 88 | Fe—25% Co | Heptane(C₇H₁₄), XeF₄ (5.0 wt %) | <10 | 140 | 500 | 1.25 | 1.96 | |
| | | TbF₃ (0.1 wt %) | | | | | | |
| 89 | Fe—52% Co—8% V—4% Cr | — | — | — | — | 0.04 | 1.21 | Values before treatment in No. 90 |
| 90 | Fe—52% Co—8% V—4% Cr | Heptane(C₇H₁₄), XeF₂ (5.0 wt %) | <100 | 130 | 400 | 0.58 | 1.24 | |
| 91 | MnBi | — | — | — | — | 0.97 | 0.65 | Values before treatment in No. 92-93 |
| 92 | MnBi | Hexane(C₆H₁₄), XeF₂ (0.01 wt %) | <10 | 80 | 600 | 1.15 | 0.88 | |
| 93 | MnBi | Hexane(C₆H₁₄), XeF₂ (0.01 wt %), | <10 | 120 | 600 | 1.28 | 0.95 | |
| | | NH₃ (0.5 wt %) | | | | | | |
| 94 | Ni₃Fe | — | — | — | — | 0.01 | 0.51 | Values before treatment in No. 95 |
| 95 | Ni₃Fe | Hexane(C₆H₁₄), XeF₂ (0.01 wt %) | <10 | 150 | 600 | 0.86 | 0.75 | |
| 96 | Fe₃Ga | — | — | — | — | 0.02 | 0.47 | Values before treatment in No. 97 |
| 97 | Fe₃Ga | Hexane(C₆H₁₄), XeF₂ (0.01 wt %) | <10 | 150 | 600 | 0.71 | 0.65 | |

TABLE 1-5

| | | | | | Diffusion heat | | | |
|---|---|---|---|---|---|---|---|---|
| | | | Particle size of fluoride | Treatment | treatment | Coercive | Residual magnetic | |
| | | | in treatment solution | temperature | temperature | force | flux density | |
| No. | Material to be treated | Main components in treatment solution | (μm) | (° C.) | (° C.) | (MA/m) | (T) | Remarks |
| 98 | Fe₃Si | — | — | — | — | 0.01 | 0.87 | Values before treatment in No. 99 |
| 99 | Fe₃Si | Hexane(C₆H₁₄), XeF₂ (0.01 wt %) | <10 | 140 | 600 | 0.74 | 0.88 | |
| 100 | Fe₂Al | — | — | — | — | 0.01 | 0.79 | Values before treatment in No.101 |
| 101 | Fe₃Al | Hexane(C₆H₁₄), XeF₂ (0.01 wt %) | <10 | 130 | 600 | 0.93 | 0.82 | |
| 102 | FeMn | — | — | — | — | <0.01 | <0.02 | Values before treatment in No.103 |
| 103 | FeMn | Hexane(C₆H₁₄), XeF₂ (0.1 wt %) | <10 | 130 | 600 | 0.52 | 0.65 | |
| 104 | FePt | — | — | — | — | 0.60 | 0.75 | Values before treatment in No.105 |
| 105 | FePt | Hexane(C₆H₁₄), XeF₂ (0.1 wt %) | <10 | 120 | 600 | 0.97 | 0.89 | |
| 106 | CoFe₂O₄ | — | — | — | — | 0.25 | 0.32 | Values before treatment in No.107-108 |
| 107 | CoFe₂O₄ | Hexane(C₆H₁₄), XeF₂ (0.5 wt %) | <1000 | 150 | 450 | 0.28 | 0.37 | |
| 108 | CoFe₂O₄ | Phenol(C₆H₅OH), XeF₂ (0.5 wt %) | <1000 | 150 | 500 | 0.35 | 0.48 | |
| 109 | Fe_{0.20}TaS₂ | — | — | — | — | 0.32 | 0.21 | Values before treatment in No.110-111 |
| 110 | Fe_{0.25}TaS₂ | Hexane(C₆H₁₄), XeF₂ (0.5 wt %) | <10 | 100 | 500 | 0.45 | 0.25 | |
| 111 | Fe_{0.20}TaS₂ | Ethanol(C₂H₅OH), XeF₂ (0.1 wt %) | <1 | 70 | 450 | 0.55 | 0.32 | |
| 112 | Co₃C | — | — | — | — | 0.40 | 0.05 | Values before treatment in No.113-114 |
| 113 | Co₃C | Hexane(C₆H₁₄), XeF₂ (0.5 wt %) | <10 | 100 | 400 | 0.43 | 0.16 | |
| 114 | Co₃C | Ethanol(C₂H₅OH), XeF₂ (0.1 wt %) | <1 | 60 | 350 | 0.46 | 0.36 | |
| 115 | Fe₃Se₄ | | — | — | — | 0.40 | 0.05 | Values before treatment in No.116-117 |
| 116 | Fe₃Se₄ | Hexane(C₆H₁₄), XeF₂ (0.5 wt %) | <10 | 120 | 450 | 0.51 | 0.07 | |
| 117 | Fe₃Se₄ | Ethanol(C₂H₅OH), XeF₂ (0.1 wt %) | <1 | 60 | 500 | 0.64 | 0.21 | |
| 118 | LaSmMnO₄ | | — | — | — | 0.16 | 0.29 | Values before treatment in No.119-120 |
| 119 | LaSmMnO₄ | Hexane(C₆H₁₄), XeF₂ (0.5 wt %) | <100 | 150 | 600 | 0.24 | 0.31 | |
| 120 | LaSmMnO₄ | Phenol(C₆H₅OH), XeF₂ (0.5 wt %) | <100 | 80 | 650 | 0.36 | 0.48 | |
| 121 | Fe₄N | — | — | — | — | 0.02 | 1.40 | Values before treatment in No.122-124 |
| 122 | Fe₄N | Hexane(C₆H₁₄), XeF₂ (0.5 wt %) | <2000 | 150 | 350 | 0.13 | 1.41 | |
| 123 | Fe₄N | Hexane(C₆H₁₄), XeF₂ (0.5 wt %) | <2000 | 120 | 350 | 0.35 | 1.47 | |
| | | SmF₃ (0.5 wt %) | | | | | | |
| 124 | Fe₄N | Ethanol(C₂H₅OH), XeF₂ (0.5 wt %) | <0.01 | 60 | 400 | 0.41 | 1.57 | |

TABLE 2

| | | | | Unevenly | |
|---|---|---|---|---|---|
| | Material to be | Diffusing | Treatment | distributed | Main grain |
| Magnet | diffused | material | temperature | element | boundary phase |
| Dy vapor | Nd₂Fe₁₄B - | Dy | 800° C. | Dy | (Nd,Dy)₂O₃₋ₓ |
| grain | based sintered | | or more | | |
| boundary | magnet | | | | |
| diffusion | | | | | |
| magnet | | | | | |
| Tb-based | Nd₂Fe₁₄B - | TbF₃ etc. | 600° C. | Tb, F | (Nd,Tb)OF |
| grain | based sintered | | or more | | |
| boundary | magnet | | | | |
| diffusion | | | | | |
| magnet | | | | | |
| Fluorinated | Nd₂Fe₁₄B - | Fluorine | 50~400° C. | Fluoride-forming | NdOxFy(y > x) |
| magnet | based sintered | (F) | | element | |
| | magnet | | | contained in | |
| | | | | magnet before | |
| | | | | F-treatment | |

### REFERENCE SIGNS LIST

1 Main phase crystal grain
2 Fluorine-containing phase in main phase
3 Grain boundary phase
4 Fluorine-containing phase at grain boundary triple point

1. A sintered magnet comprising a NdFeB main phase and a grain boundary phase, wherein
the grain boundary phase contains an oxyfluoride;
a concentration of fluorine in the oxyfluoride is higher than a concentration of oxygen in the oxyfluoride;
the concentration of fluorine in the oxyfluoride decreases depthwise from a surface of the sintered magnet; and
saturation magnetic flux density of the sintered magnet decreases depthwise from the surface of the sintered magnet.

2. The sintered magnet according to claim 1, wherein a volume fraction of the oxyfluoride decreases depthwise from the surface of the sintered magnet.

3. The sintered magnet according to claim 1, wherein the concentration of fluorine in the oxyfluoride is higher than 33 atom % in terms of an average value in a region within 100 μm depthwise from the surface of the sintered magnet.

4. The sintered magnet according to claim 1, wherein the oxyfluoride comprises a cubic or tetragonal crystal structure.

5. The sintered magnet according to claim 1, wherein a fluorine content of the whole sintered magnet is 5 atom % or less.

6. The sintered magnet according to claim 1, wherein a concentration of oxygen in the whole sintered magnet is 3000 ppm or less.

7. The sintered magnet according to claim 1, wherein iron or an iron alloy contained in the main phase has a bcc or bct structure, and the iron or the iron alloy decreases depthwise from the surface of the sintered magnet.

8. The sintered magnet according to claim 1, wherein the oxyfluoride comprises NdOₓF₃₋₂ₓ (0<x<1) of a tetragonal crystal structure.

9. A Method for producing a sintered magnet, comprising: introducing fluorine by using a dissociative fluorinating agent in a step of producing a sintered magnet according to claim 1.
